(19) United States
(12) Patent Application Publication
(10) Pub. No.: US 2005/0090373 A1
(43) Pub. Date: Apr. 28, 2005

(54) Folding-aid mark and method of determining the folding quality on folded products

(75) Inventors: Dieter Schmid, Todtenweis (DE); Jurgen Schuster, Augsburg (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen Ag

(21) Appl. No.: 10/974,627

(22) Filed: Oct. 27, 2004

(30) Foreign Application Priority Data
Oct. 28, 2003 (DE) 103 50 405.2

(51) Int. Cl. B31B 1/00

(52) U.S. Cl. 493/11

(57) ABSTRACT

A folding-aid mark on a folded product, includes a folding mark for identifying the intended course of a fold, and additional lines for identifying the tolerance limits of a predefined tolerance range in the region of the folding mark.

### BACKGROUND OF THE INVENTION

1. Field of the Invention

The invention relates to a folding-aid mark and a method of determining the folding quality on folded products.

2. Description of the Related Art

It is generally known to fold printed products in many ways following printing. For example, center-parallel, zigzag, wound or window folds are known.

In addition to what are known as register marks, to monitor whether the various mixed colours of an image have been printed exactly on one another, lines for illustrating the course of a folding line on the finished product may also be applied to a printing plate.

By using the folding line identifier, the operator is able to detect whether the actual fold corresponds to the desired course (intended course) when setting up a new production run. If the fold does correspond to the desired course, production may be started without further adjustment of the folding setup. However, if the fold lies beside the folding line identifier, the operator must check whether the fold is still within a predefined tolerance. In this case, too, the production could be started, assuming that the product also meets all other requirements (print quality and so on). However, measuring the distance between the folding line and its intended course is complicated and can be time intensive. In the case of products with a plurality of successive folds, each fold position must be measured and each necessary correction must be assigned to the correct folding device.

In folders whose folding adjustment can be set up in “off-line” operation, that is to say folders which can be stopped following the production of a single folded product, the number of rejects that occur is limited to a small amount. However, a long time may be required until the desired folding accuracy is set.

In folding devices which have to be set in “in-line” operation, that is to say at their full production speed—dependent on the type of fold and the type of paper used—a large number of wrongly folded products can be produced during the setting. The amount of rejects increases the longer the setting of the correct fold position lasts. In this case, the setting time also depends substantially on how quickly a folding inaccuracy can be registered.

### SUMMARY OF THE INVENTION

It is an object of the present invention to provide a device and a method with which folding inaccuracies can be registered more quickly than the prior art.

The object of the present invention is achieved by.

The folding-aid marking according to the present invention allows an operator to quickly detect visually whether a fault lies within the predefined folding tolerance and what quality a fold has. As a result, the folding accuracy of folders can be set substantially more quickly, so that the reject rate and/or the setup time is advantageously improved.

The folding-aid mark according to the present invention may be divided with a graduated scale, such that a measure of the deviation of a fold from its intended course may be read directly on the product.

The folding mark according to the present invention may also refer the operator in a supportive manner to the associated setting mechanisms which have to be adjusted on the folder in order to eliminate the inaccuracy in the assessed fold. In addition to the reference as to which adjustment mechanism is to be adjusted, the folding mark according to the invention may additionally also refer to the adjustment direction.

The folding mark according to the invention acts particularly advantageously in the case of products with a plurality of folds which are folded directly following a preceding printing process and whose folding quality has to be set at full production speed.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended Claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a front view of a printing plate with a plurality of folding-aid marks according to the invention,

FIG. 2 is a front view of an individual folding-aid mark in enlarged form in the area labelled II in FIG. 1,

FIG. 3 is perspective view of a front and side of a product with folding-aid marks according to the present invention,

FIG. 4 is an enlarged front view of a folding-aid mark according to the present invention on a folded product from the area IV in FIG. 3,

FIGS. 5 and 6 are front views of folding-aid marks according to the present invention, and

FIG. 7 is a view of the folding-aid mark from FIG. 5 on a folded product according to the detail IV from FIG. 3.

### DETAILED DESCRIPTION OF THE PRESENTLY PREFERRED EMBODIMENTS

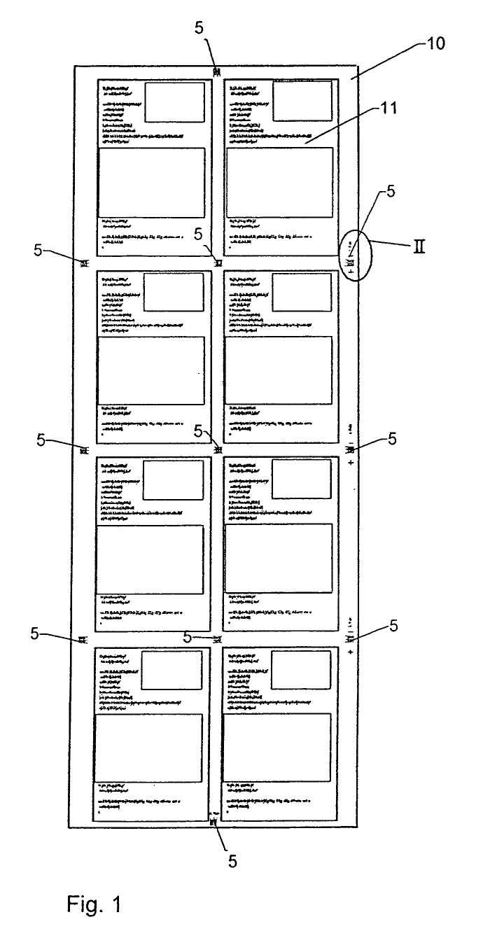

FIG. 1 shows, by way of example, a printing plate 10 with images 11 for a 16-page printed and folded product. This printing plate 10 can be clamped onto a press cylinder of a printing press and, by means of printing ink, transfers the images 11 to a printing material. After printing, the printed product can be folded in many different ways. For the processing of printing material webs, folders are provided directly at the web outlet from the printing press with which the printing material web can be folded and/or cut longitudinally and/or transversely.

The folding accuracy of folds on folded products is predefined by the folding tolerance. The magnitude of the folding tolerance is firstly defined by stipulations from appropriate specialist groups belonging to the specialist associations and secondly can be predefined by the quality demands of the customer.

When setting up a new production run, both the printing process and the folder have to be set up to achieve the predefined tolerances and qualities of the print and of the folds. For this purpose, the printing press is started up and samples are taken at the product delivery and checked for quality. Depending on where deviations from the desired values are determined, the settings must then be corrected appropriately at respective setting mechanisms.

In folders which, on account of dynamic influences, have to be set at full production speed—depending on the type of fold and the type of paper—it is particularly advantageous to be able to determine a measure of the deviations quickly. For this purpose, between the individual pages or images 11, in each case at the points where folds are provided, folding-aid marks 5 according to the invention are arranged on the printing plate 10. These folding-aid marks 5 are applied to the printing material during the printing process and identify the desired course of a fold on the products.

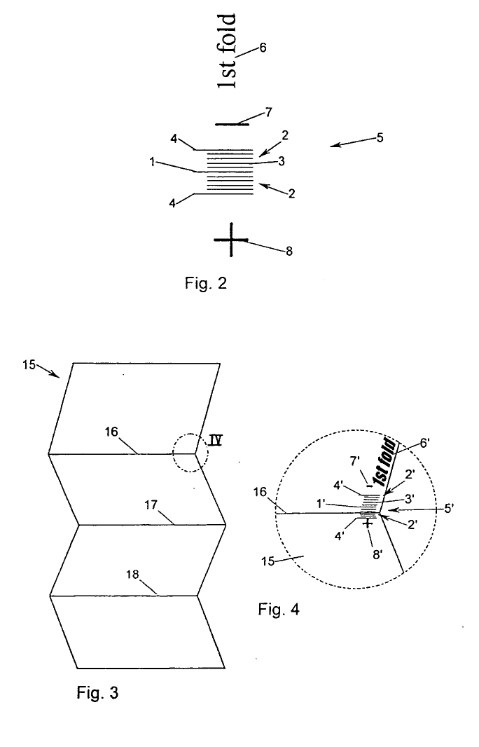

In FIG. 2, a folding-aid mark 5 is illustrated in enlarged form in the detail II from FIG. 1. The central line 1, also known as the folding mark 1, represents the intended course of the fold. Further lines on both sides of the folding mark 1 are used to identify the tolerance limits 4. If the folding line runs between these tolerance limits 4, the folding corresponds to the required quality. The distances on both sides between the folding mark 1 and the tolerance limits 4 can be divided uniformly in a particularly advantageous way by using divisions 3 and then embody a scale 2. The scales 2 may of course also be led further beyond the tolerance limits 4.

In addition to the tolerance limits 4, the folding-aid marks 5 may also contain further references for the operator. For example, a reference to the setting mechanism 6 can be provided. For example, the reference “1^{st} fold” indicates to the operator at which setting screw he must make corrections to the folder. Adjustment direction identifiers 7, 8 with “+” (plus) and “−” (minus) signal to the operator whether the course of the fold runs in the negative or positive range, from which he can gather a reference to the adjustment direction to correct the position of the folding line.

FIG. 3 shows a folded product 15 in the form of a zigzag fold having a first fold 16, second fold 17 and third fold 18. In order to evaluate the courses of the folds by the folding-aid marks according to the invention, the folded product 15 has been unfolded again. The folds in each case leave behind a line on the folded product 15 in the course of a folded edge, so that the course of the folds is also still visible on the unfolded folded product 15.

The detail IV shows a folding-aid mark printed onto the printing material at the first fold 16 and is illustrated in enlarged form in FIG. 4. At the lateral edge of the folded product 15, a folding-aid mark 5′ having a folding mark 1′ for identifying the ideal course of the fold can be seen. Furthermore, on both sides of the folding mark 1′, the tolerance limits 4′ are printed onto the folded product, as are the divisions 3′ of the scales 2′. As the illustration shows, the first fold 16 does not run through the folding mark 1′ but between the second and third divisions in the positive range. The fact that this is the positive range can be read off by the operator from the “+” symbol which is provided as a reference to the adjustment direction 8′. From the reference “1^{st} fold” to the setting mechanism 6′, the operator is able to gather that he must make a correct the setting on the first fold on the folder in order to achieve the ideal course.

The distances of the divisions 3′ are preferably matched to the adjustment steps on the folder, so that, in the example illustrated, the operator can adjust the first fold on the folder by 2.5 units in the minus direction in order to reach the ideal course. Since the folding accuracy can change slightly from product to product on account of external influences, it is expedient to evaluate a plurality of folded products. In the present example, it would also be possible to draw the conclusion to maintain the settings on the folder, since the folding accuracy lies within the tolerance limits.

In the event of lower requirements on the fold quality, it can be expedient to dispense with the divisions 3, 3′ and to identify only the tolerance range by means of the tolerance limits 4, 4′. The operator can then merely determine whether the fold lies within the predefined tolerance and adjusts the folder only if the tolerance is exceeded.

For the purpose of easier registration of the course of the fold within the folding-aid mark, the strokes or lines of the folding mark 1, 1′ and/or of the tolerance limits 4, 4′ can be designed to be longer than those of the divisions 3, 3′.

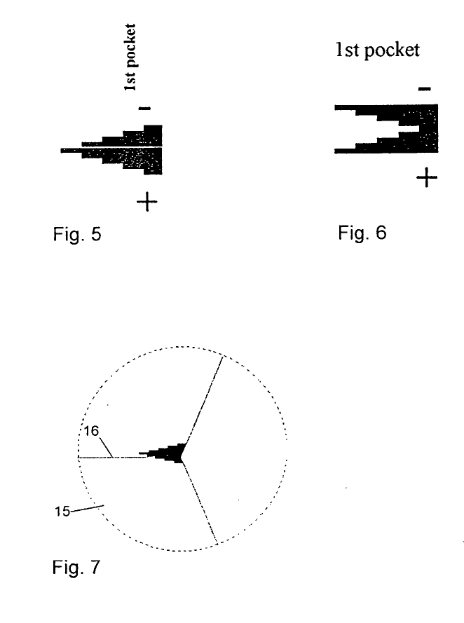

Instead of the graduated scale described, other scale embodiments may of course also be provided. For instance, a stepped pyramid, which is provided on the first pocket of a pocket fold, is illustrated in FIG. 5. Depending on the step through which the fold runs, the operator is able to read off by how many units the fold deviates from its intended course and make appropriate corrections on the folder. In FIG. 6, the stepped pyramid from FIG. 5 is illustrated inverted. A measure of the fold deviation may also be read off on this scale embodiment in accordance with the present invention.

FIG. 7 illustrates how the folding-aid mark shown in FIG. 5 would be applied to the area of detail IV from FIG. 3. As can be seen from the drawing, the fold runs approximately through the first step of the pyramid, so that the operator can derive from this the fact that he must adjust the folder approximately by one unit.

If, in the envisaged course of a fold, folding-aid marks are in each case provided in the starting region, in the final region and in the central region, it is also possible to register a fold which runs obliquely.

According to the present invention, folding-aid marks are applied to a folded product before folding, from which a measure of a fold deviation can be read off directly in order to determine the folding quality. The folding-aid marks identify the tolerance range around the predefined intended course of a fold and are preferably implemented as a scale, divided with strokes or other divisions. Following the folding, by using the course of the folding line through the associated folding-aid mark on the folded product, it is possible to read off the extent to which the fold deviates from its intended course and corrections can be made on an associated setting mechanism of the folder.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the Claims appended hereto.

1. On a folded product, a folding-aid mark comprising a folding mark identifying an intended course of a fold and additional lines representing tolerance limits for identifying a predefined tolerance range in the region of the folding mark.

2. On a folded product according to claim 1, wherein the folding-aid mark further includes divisions uniformly dividing the tolerance range into a scale, such that a measure of the deviation of the fold from its intended course is readable directly from the folded printed product.

3. On a folded product according to claim 2, wherein each of the folding mark, the tolerance limits and the divisions comprise lines on the folded printed product, the lines of at least one of the folding mark and the tolerance limits being longer than those of the divisions.

4. On a folded product according to claim 1, wherein the folding-aid mark includes a reference to the adjustment direction on a setting mechanism on the folder.

5. On a folded product according to claim 1, wherein the folding-aid mark includes a reference to the associated setting mechanism on the folder.

6. On a folded product according to claim 2, wherein each of the divisions on the scale of the folding-aid mark corresponds to a division on an associated setting mechanism in the associated folder.

7. On a folded product according to claim 1, further comprising a plurality of folding-aid marks in the envisaged course of a fold for determining an obliqueness of the fold.

8. On a folded product according to claim 1, wherein the folding-aid mark is applied by a printing process.

9. A printing plate operatively arranged for printing at least one folding-aid mark on a product, the at least one folding-aid mark comprising a folding mark identifying an intended course of a fold and additional lines representing tolerance limits for identifying a predefined tolerance range in the region of the folding mark.

10. A method of determining the folding quality of a fold on a folded product, comprising the steps of:
applying folding-aid marks on a product before folding the product, the folding-aid marks having scales allowing the direct determination of a measure of a folding deviation;
evaluating the folding accuracy on the finished folded products using the folding-aid marks for determining deviations of a fold from the intended course of the fold; and
correcting the determined deviations using an associated setting mechanism of the folder.

11. The method of claim 10, wherein said step of applying comprises printing the folding-aid marks on the product.
